(19) United States
(12) Patent Application Publication
(10) Pub. No.: US 2004/0079021 A1
(43) Pub. Date: Apr. 29, 2004

(54) Fishing apparatus

(76) Inventor: Czeslaw Mazur, Placentla, CA (US)

Correspondence Address: Czeslaw Mazur, 734 W LaJolla St. #205, Placentia, CA, 92870, US

(21) Appl. No.: 09/911,347

(22) Filed: Jul. 24, 2001

(51) Int. Cl. A01K 97/10

(52) U.S. Cl. 43/21.2

(57) ABSTRACT

An apparatus for mounting and actuating a fishing rod. The apparatus is secured to a fixed surface such as a dock, boat railing or beach or ice surface, and a fishing rod is fixedly mounted at its handle portion in a conventional fishing position. The apparatus includes a powerful spring which is maintained in a wound and latched position whereby when a fish bites the bait at the end of the line, the resulting tug on the line releases the latch and the unwinding of the spring rapidly rotates the fishing rod upwardly about is handle portion. This rapid upward movement serves to seat the hook into the fish to ensure a successful retrieval and further serves to alert the fisherman of a bite, especially when the rod is unattended.

### BACKGROUND OF THE INVENTION

The present invention is intended to provide a new and improved apparatus for construction for fishing, more particularly for mounting and holding a rod during the waiting portion of the fishing process. It also serves to permit one fisherman to engage in multiple rod fishing and to alert the fisherman in the event of a bite on any of the lines.

In the past there have been a number of fishing rod holders available that maintain the rod in an operative position and snap the rod upwardly upon a bite at the bait. These devices have found particular application for ice fishing and in smaller commercial applications so one fisherman could simultaneously utilize a plurality or rods. While these prior art devices operated as intended, they were not without a number of problems and disadvantages. For example, many of them utilized a mousetrap type spring and latch arrangement requiring a very large spring and moving it into an operative position was quite difficult and required considerable strength. In addition, if the spring was unlatched by accident it could cause significant injury.

### BRIEF SUMMARY OF THE INVENTION

It is the general aim of the present invention to provide a new and improved spring powered fishing rod holder that is safe, compact, economical to construct and provide an ease use that has not heretofore been obtained.

It is another object of the invention to provide a fishing rod holder and bite actuator that can be readily mounted under all circumstances including boat railings, dock railings and beach and sand surfaces.

### BRIEF DESCRIPTION OF THE DRAWING

Additional objects and advantages of the invention will appear from the following description taken in conjunction with the accompanying drawings in which:

FIG. 1 is a perspective view of an exemplary rod holder embodying the features of the present invention; and

FIG. 2 is a perspective exploded view showing the invention in an unassembled configuration.

While the present invention is susceptible of various additional modifications and alternative constructions, illustrative embodiments are shown in the drawings and will herein be described in detail. It should be understood however, that it is not to be intended to limit the invention to the particular forms disclosed, but, on the contrary, the invention is intended to cover all modifications, equivalents, and alternative construction falling within the spirit and scope of the invention as expressed in the appended claims.

### DETAILED DESCRIPTION OF THE PREFERRED EMBODIMENT

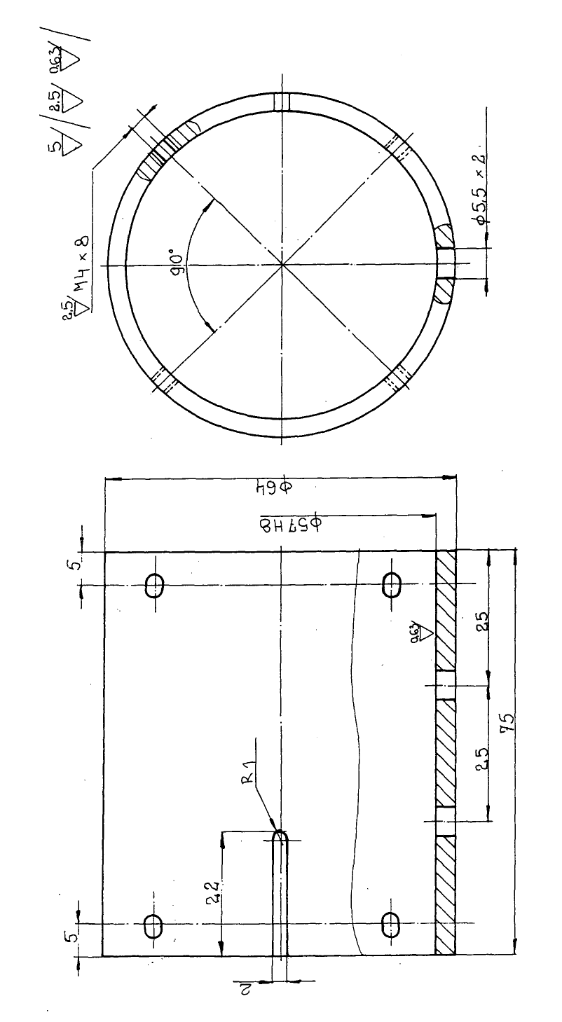

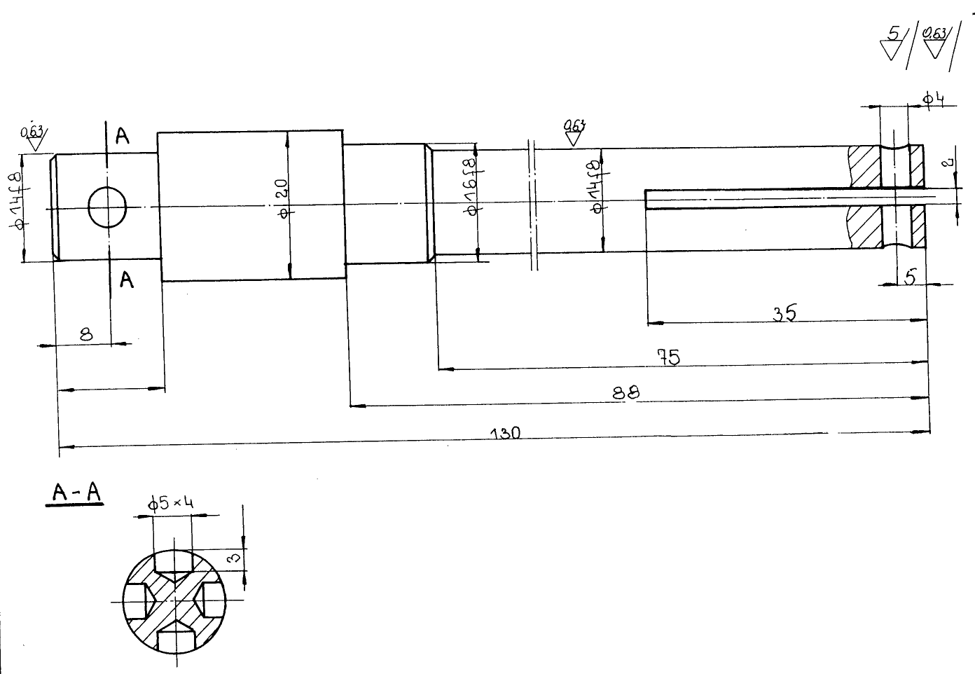

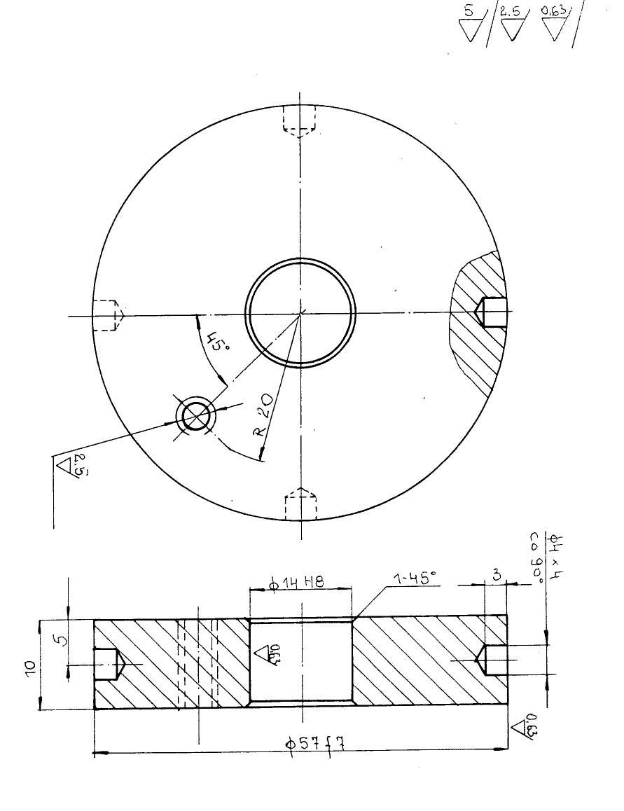

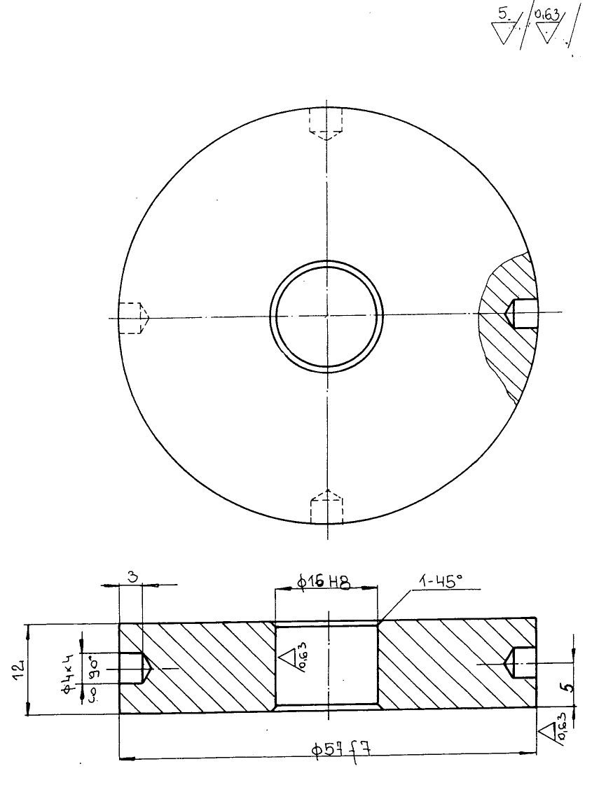

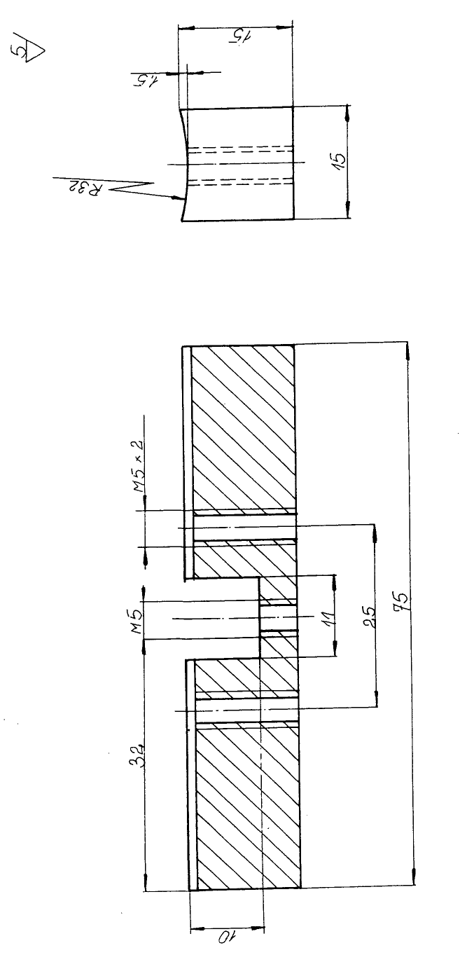

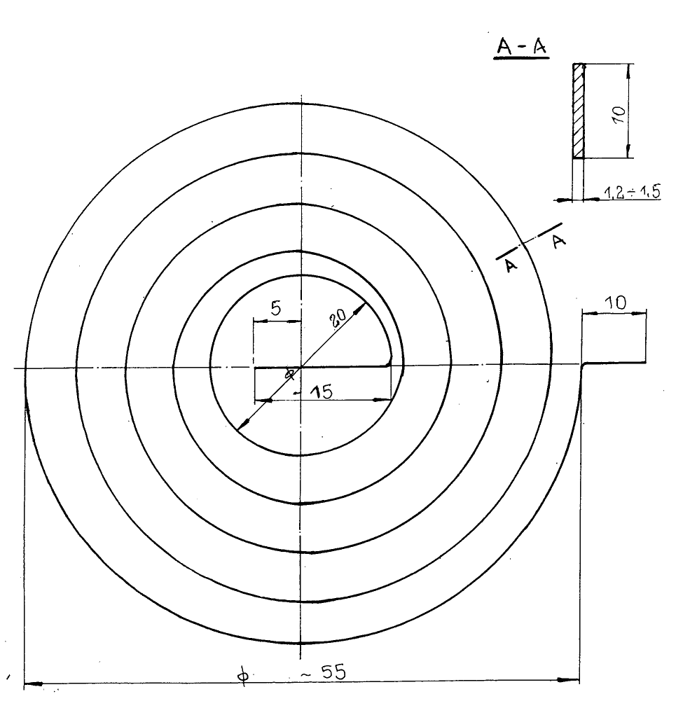

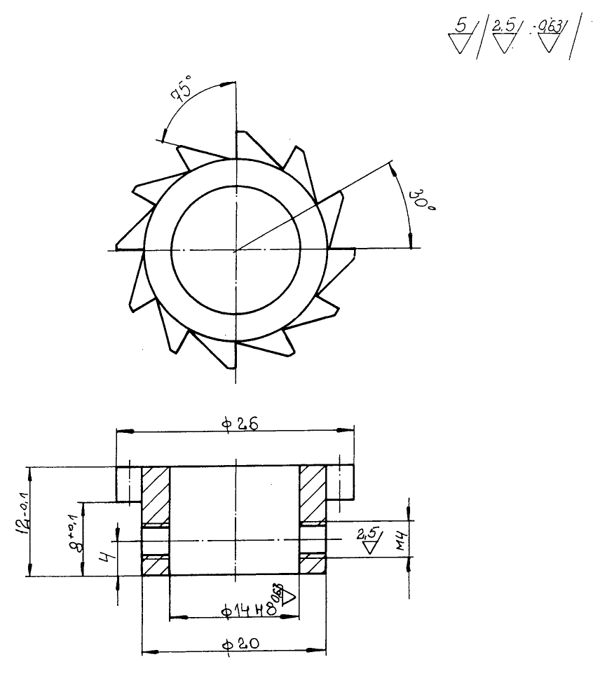

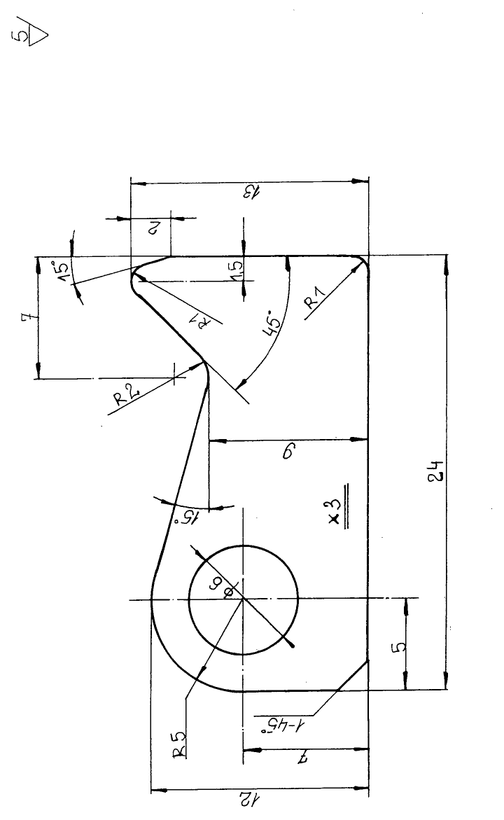

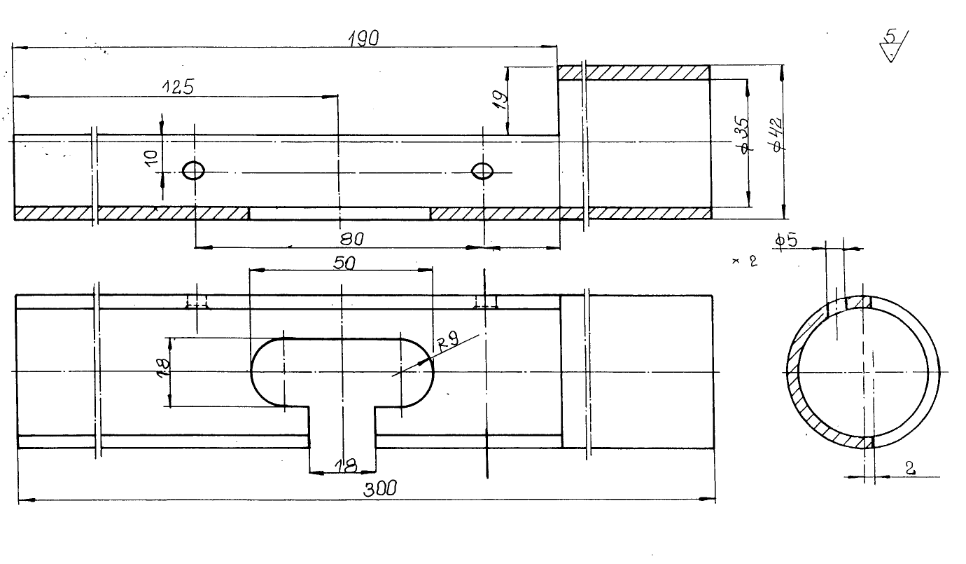

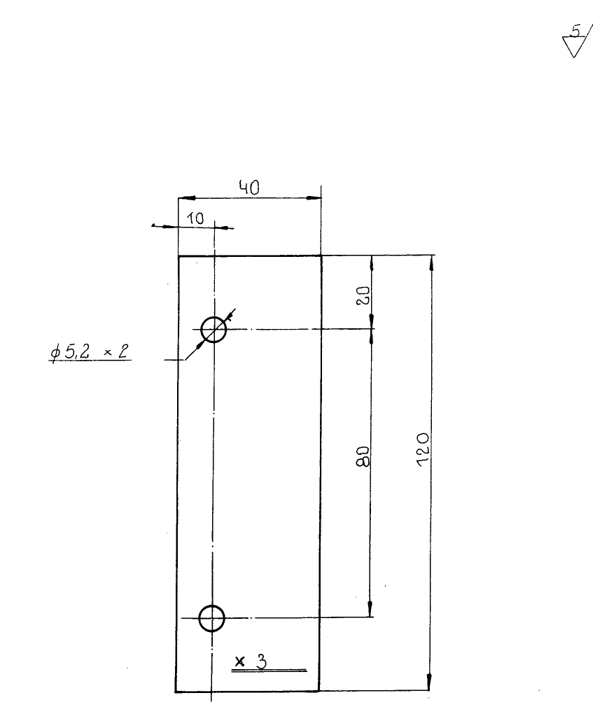

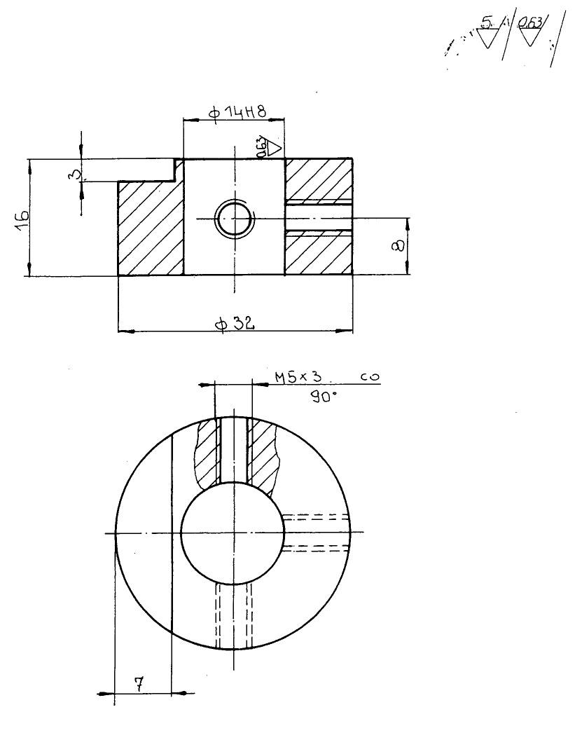

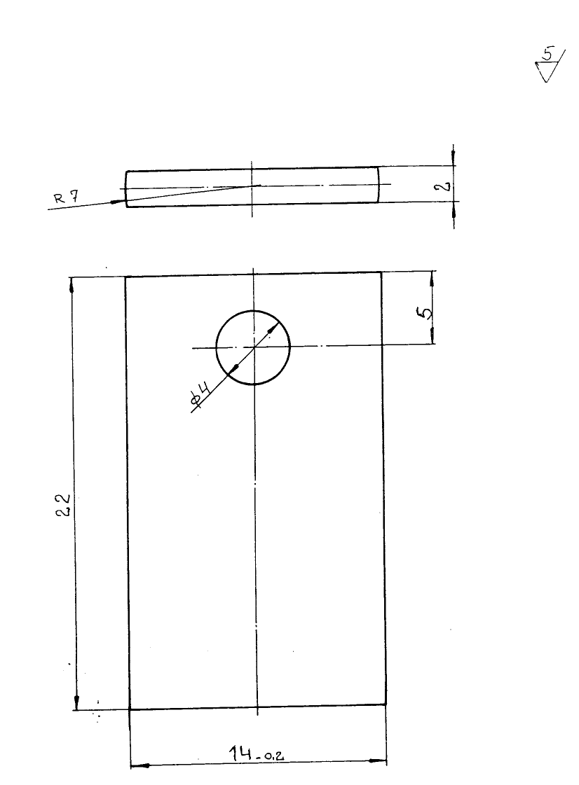

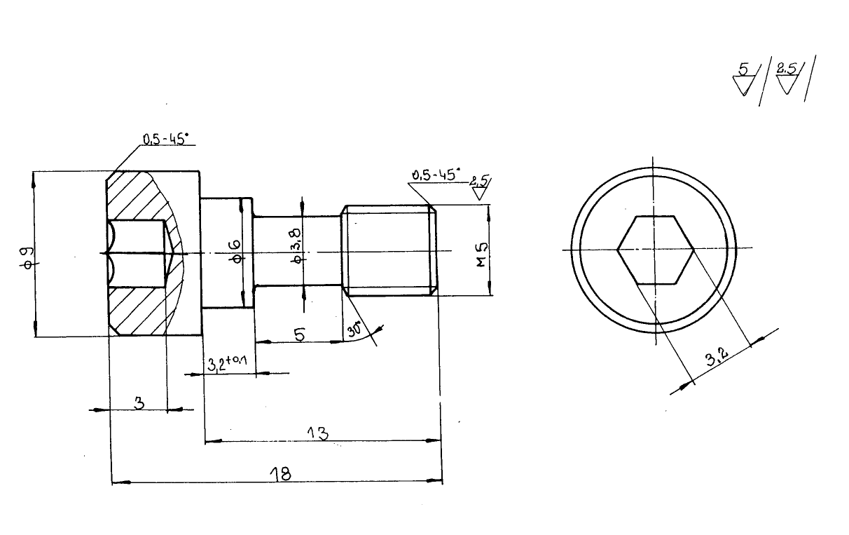

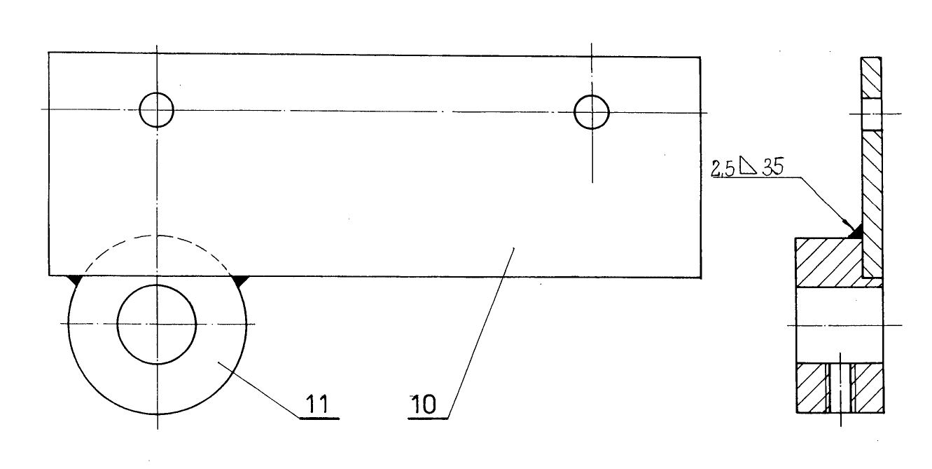

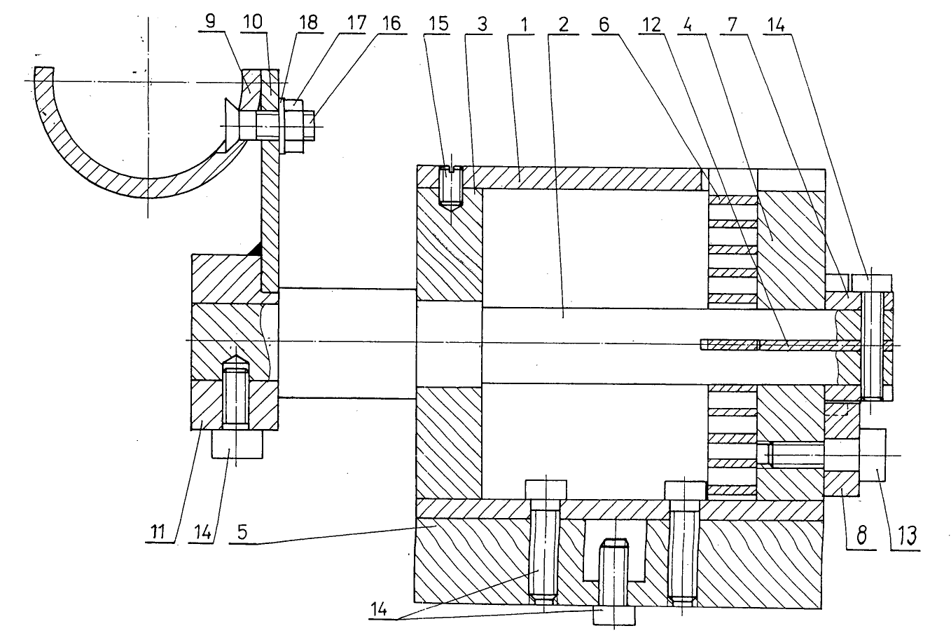

Referring collectively to FIG. 1 and FIG. 2., an exemplary graphic construction generally indicated at 10 is illustrated which includes a cylindrical housing 11 to which a conventional fishing rod can be mounted and which can also be mounted to a deck, railing or placed in sand or be driven into ice. In order to mount the housing 11 to a desired fixed support, a mounting bracket 12 is affixed to housing 11 which receives a removable post 13 which can be driven into sand or ice or clamped to a boat or pier railing before being inserted into the mounting bracket 12 and affixed by means of a retaining screw 14.

In keeping with the objects of the invention, the apparatus 10 has to be provided with means to respond to a fish biting the bait on the hook at the end of the line and quickly moving the rod upward to secure the hook in a manner similar to a quick upward movement of the wrist of a fisherman holding a rod. This is accomplished by providing a spring loaded latchable holder for a rod.

As shown in FIG. 2, housing 11 is provided with covers 15 and 16 which are each provided with center holes 17 to rotatably receive shaft 18. Inside the housing 11 a coiled spring 19 is provided having a tab 21 at one end which is received by a slot 22 in shaft 18 and a tab 23 at the other end which is received by a slot 24 provided in the side wall of the housing 11.

In order to latch the shaft 18 in a position where the spring 19 is in a tightly coiled condition, a ratchet 26 is affixed to the end of shaft 18 passing through cover 16 which can be engaged by a moveable pawl 27 affixed to cover 16 by screw 28 which is stepped to allow the pawl to freely rotate.

At the other end of shaft 18, a rod holder 30 is securely mounted. By contouring the holder in with a curved rod receiving channel 31, most conventional fishing rods can be received therein and secured thereto by any number of conventional means such as velcro straps.

In operation the apparatus would be mounted whereby the rod is at about a 45 degree angle with the horizontal. The rod is then rotated to a horizontal position which tightens the spring 19 and the rod remains in the horizontal position by virtue of the pawl engaging the ratchet. To ensure this movement and provide stop means, cover 15 is provided with a forty five degree depression 33 which is engaged by a screw 34 affixed to shaft 18.

When a fish bites the bait on the hook and provides tension to the line, the rod is rotated enough to cause the pawl 27 to release the spring loaded shaft 18 quickly moving the rod forty five degrees which seats the hook in the fish and signals the fisherman that a bite has occurred.

1. A fishing apparatus comprising a housing having a shaft rotatably mounted therein with at least one end of said shaft comprising mounting means for a fishing rod, spring means whereby the rotation of said shaft tightens said spring, latching means whereby said shaft can be maintained in a spring loaded condition first position and will rapidly move to a second unloaded position upon the release of said latching means

2. The apparatus set forth in claim 1 wherein the movement between said first position and said second position is about forty five degrees.

3. The apparatus set forth in claim 2 wherein said latching means will release the spring loaded shaft upon a slight movement and tension applied to said shaft.

4. The apparatus of claim 3 wherein said housing is provided with means to mount the housing to a fixed surface including railings, sand and ice.

5. The apparatus of claim 4 wherein said spring means comprise a coiled spring having straight tabs at each end.

6. The apparatus of claim 5 further including stop means to ensure the forty five degree movement.
